(19) United States
(12) Patent Application Publication
(10) Pub. No.: US 2021/0299831 A1
(43) Pub. Date: Sep. 30, 2021

(54) LOCKING SNAP RING PLIER FOR 4-WHEEL-DRIVE AXLE-HUB ASSEMBLIES

(71) Applicant: Lisle Corporation, Clarinda, IA (US)

(72) Inventor: Randall J. Ploeger, Clarinda, IA (US)

(21) Appl. No.: 17/197,515

(22) Filed: Mar. 10, 2021

Related U.S. Application Data
(60) Provisional application No. 63/000,100, filed on Mar. 26, 2020.

(51) Int. Cl. B25B 27/20

(52) U.S. Cl. CPC B25B 27/205

(57) ABSTRACT

A tool for removing/installing a heavy duty snap ring that is otherwise difficult to access with standard snap ring pliers. The pliers have end configurations that provide additional clearance for the operational use of the tool within confined areas. The tool also includes a locking mechanism to hold the snap ring in an open configuration for removal/installation to the axle shaft.

### CROSS-REFERENCE TO RELATED APPLICATIONS

This application claims the benefit of U.S. Provisional Application No. 63/000,100 filed on Mar. 26, 2020. The disclosure of which is incorporated herein by reference.

### TECHNICAL FIELD

An automotive repair tool for removing and installing 4-wheel-drive hub assemblies. In particular, the tool may be used for removing/installing a heavy duty snap ring that is otherwise difficult to access with standard snap ring pliers.

### BACKGROUND OF THE INVENTION

In a principal aspect the present invention relates to a tool used by automotive repair mechanics. In particular, the invention may be used for accessing and removing/installing a heavy duty snap ring that is otherwise difficult to access within a hub assembly.

### SUMMARY OF THE INVENTION

Briefly the present invention is a tool to be used to remove; install a heavy duty snap ring within the hub assembly of 4-wheel-drive vehicles. The snap ring may be difficult to access with standard snap ring pliers due to the small amount of room between the hub and axle shaft and the location of the snap ring within the recessed area. Snap ring pliers that are small enough to fit into the cavity are often not strong enough to remove/install the heavy duty snap ring.

Thus, it is an object of the invention to provide a snap ring plier configured to fit within the cavity and that is strong enough to remove the heavy duty snap ring. The snap ring plier also includes a locking mechanism to hold the snap ring in an expanded condition for easier removal/installation of the snap ring to the axle shaft.

### BRIEF DESCRIPTION OF THE DRAWINGS

In the detail description reference will be made to the drawings comprised of the following Figures and Photos:

FIG. 1 is an isometric view of the snap ring plier.

FIG. 2 is a plan view of the snap ring plier.

FIG. 3 is an end view of the snap ring plier.

FIG. 4 illustrates a typical hub assembly 29.

FIG. 5 illustrates a partially dis-assembled hub assembly.

FIG. 6 illustrates a snap ring being removed.

FIG. 7 illustrates a different partially dis-assembled hub assembly,

FIG. 8 is a view showing the attempted removal of the snap ring shown in FIG. 4.

### DETAILED DESCRIPTION OF AN EMBODIMENT OF THE INVENTION

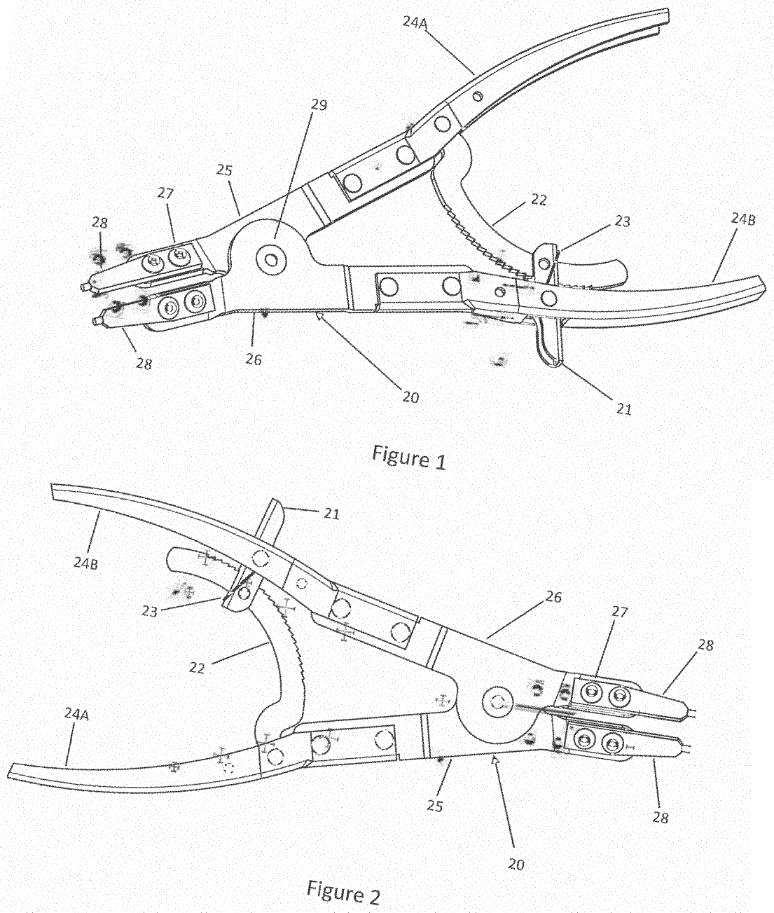

Referring to FIG. 1 and FIG. 2, the complete snap ring plier 20, consists of the following component parts: A latch 21 is pivotally attached to handle 24B. The latch 21 is biased by a spring 23 to interact with the ratcheting cam 22 to lock the pliers in an open position when removing/installing the heavy duty snap ring. The ratcheting cam 22 is pivotally attached to handle 24A. The handles 24A and 24B are attached mechanically with rivets to jaw 25 and jaw 26. Jaws 25 and 26 are pivotally attached together with a central rivet 29.

Replaceable tips 28 are attached to the Jaws 25 and 26 with removable screws 27. Tips 28 may be straight or curved. Other attachment devices could be used as alternative embodiments, e.g. rivets, welds, etc. Removable screws are the preferred embodiment as the tips could be replaced if the end of the tips were to break.

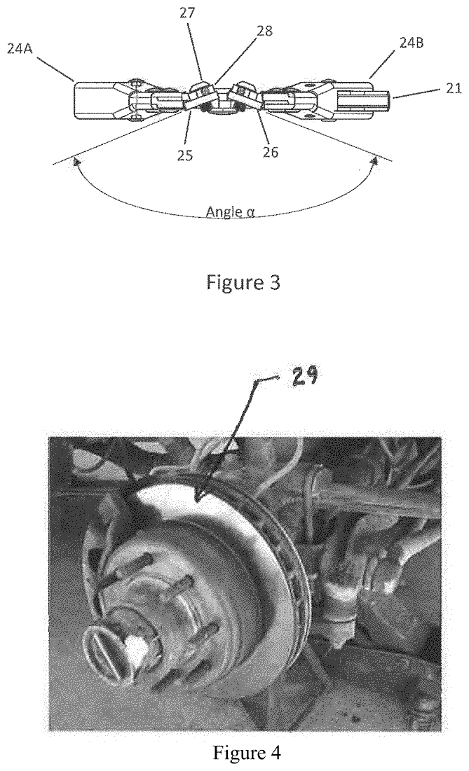

Referring to FIG. 3, the jaws 25 and 26 are formed at an angle α. Angle α is preferably between 110 and 160 degrees and most preferably 140 degrees. The angled end configuration of the jaws provides additional clearance for the operation of the tool within the small cavity of the hub-axle assembly as shown in FIGS. 4-8. The angle a provides additional clearance for the tips 28 to separate within the cylindrical recessed area to allow removal of the snap ring 35.

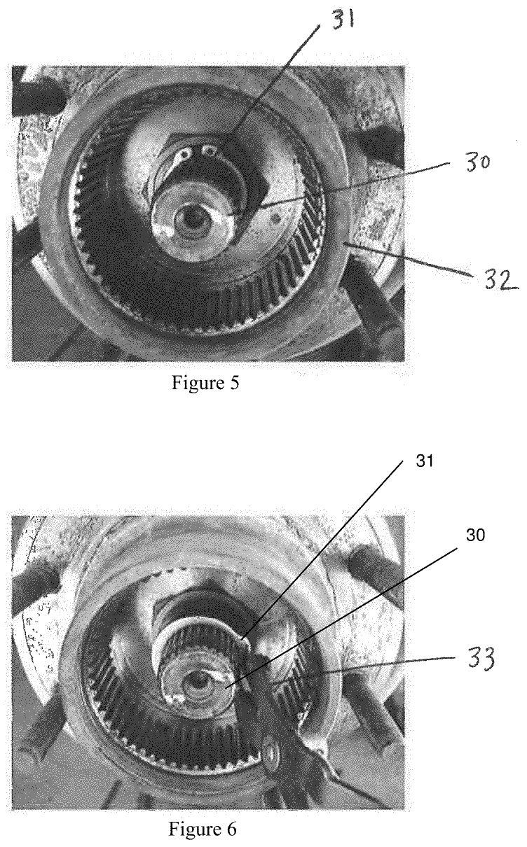

FIG. 5 shows a partially dis-assembled hub assembly with hub 32, axle 30, and the snap ring 31 to be removed.

FIG. 6 shows a conventional snap ring removal tool 33 in an easily accessible cavity between the axel 30 and hub 32.

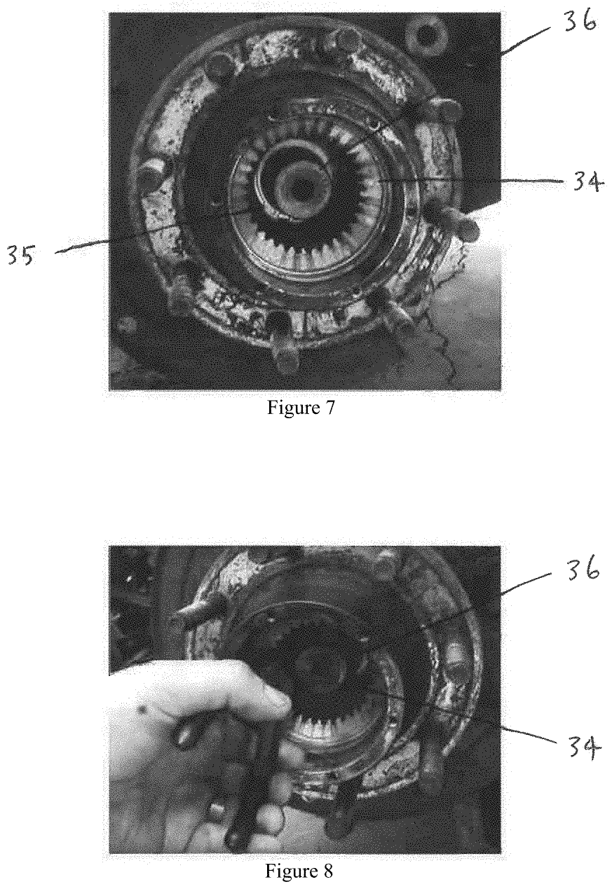

Conventional snap ring plier tools are not suited for use in hub assembly having a limited clearance in the cavity between axel 36 and hub 34 as illustrates in FIG. 7. FIG. 7 shows a common configuration of the hub 34, axle 36, and the snap ring 35 to be removed having limited clearance in the cavity.

The inventive snap ring plier tool overcomes problems with conventional snap ring pliers by readily accessing and removing snap rings from hub assemblies having a limited clearance in the cavity between the axel and hub.

What is claimed is:

1. A per for removing/installing a heavy duty snap ring comprising:
a first handle,
a second handle,
a first jaw operably connected to the first handle, the first jaw including a first tip;
a second jaw operably connected to the second handle, the second jaw including a second tip;
a cam attached to said first handle,
a latch pivotably attached to said second handle, the latch operably connected to the cam, wherein the latch contacts the cam at a first position that maintains the first and second jaws in an open position,
wherein the first and second tip are configured for engaging a snap ring.

2. The tool of claim 1 wherein the first tip and second tip are configured at an angle α relative to on another, wherein angle α is between 110 and 160 degrees.

3. The tool of claim 1 wherein the cam is a ratcheting cam.

4. The tool of claim 1 wherein the first handle is pivotably connected to the second handle.

5. The tool of claim 1 wherein the latch is spring-biased.

6. The tool of claim 1 wherein the first tip is removably attached to the first jaw, and the second tip is removably attached to the second jaw.

7. A plier for removing/installing a heavy duty snap ring comprising:
a first handle pivotably connected to a second handle,
a first jaw operably connected to the first handle,
a first tip removably connected to the first handle;
a second jaw operably connected to the second handle;
a second tip removably connected to the second handle;
a ratcheting cam attached to said first handle,
a spring-biased latch pivotably attached to said second handle, the latch operably connected to the cam, wherein the latch contacts the cam at a first position that maintains the first and second jaws in an open position,
wherein the first and second tip are configured at an angle α relative to on another, wherein angle α is between 110 and 160 degrees.
